(19) United States
(12) Patent Application Publication
(10) Pub. No.: US 2006/0210130 A1
(43) Pub. Date: Sep. 21, 2006

(54) Ultrasonic doppler system for determining movement of artery walls

(76) Inventors: Laurence Germond-Rouet, Paris (FR); Odile Bonnefous, Rueil-Malmaison (FR)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(21) Appl. No.: 10/538,154

(22) PCT Filed: Dec. 12, 2003
(86) PCT No.: PCT/IB03/05928

§ 371 Date: Nov. 7, 2005

(30) Foreign Application Priority Data
Dec. 18, 2002 (EP) 02293134.9

(51) Int. Cl. G06K 9/00

(52) U.S. Cl. 382/128

(57) ABSTRACT

The invention relates to an ultrasonic viewing system, for displaying images of an artery using a curved array of transducer elements, comprising means for acquiring (51) of an ultrasonic image sequence and a Doppler color sequence of a segment of artery explored along its longitudinal axis and having walls moving in relation with the cardiac cycle; and comprising processing means for: estimating the velocity and motion amplitude (53, 54, 55) of the artery walls along Doppler color ultrasound scanning lines; estimating the motion amplitude (58) of the artery walls along lines perpendicular to the artery global axis; and further comprising: display means for displaying (60) curves of this last artery wall amplitude on a dedicated display on which the user may have interaction. The invention further relates to an image processing method having steps to be carried out using this system.

### FIELD OF THE INVENTION

The invention relates to an ultrasonic imaging system, and/or an ultrasonic examination apparatus, for acquiring a sequence of medical images of an artery segment using a curved array of transducer elements. The invention further relates to an image processing method for processing the images produced by said system and particularly for displaying an ultrasonic image sequence of an artery segment with indications of arterial parameters in function of the cardiac cycle. The invention is used in the field of ultrasonic imaging, to provide a cardio-vascular non-invasive medical tool for examining patients suspected to present anomalies of arteries and notably anomalies of the aorta such as aortic aneurysms.

### BACKGROUND OF THE INVENTION

An ultrasonic image processing method for calculating dilation curves related to an artery segment is already known from the U.S. Pat. No. 05,579,771 (Bonnefous, Dec. 3, 1996). This document describes a method for characterizing an artery segment by ultrasonic imaging, using an array of ultrasonic transducers that produces a sectional frame, which is formed by image lines of a number of successive parallel excitation lines extending perpendicularly to the artery axis. Said array is coupled to a transmitter/receiver circuit, which provides high frequency signals to a signal processing system. Said system determines the arterial walls radial velocity and displacement amplitude values and further determines an arterial dilation curve in function of location and time. Such a curve is constructed by points representing the arterial dilation value in the arterial radial direction Z, at a given location corresponding to an excitation line along the longitudinal X-axis of the artery, in function of excitation instants t, during a cardiac cycle. So, FIG. 4C of this document shows, superposed, the different dilation curves related to all the excitation lines of an ultrasonic signal corresponding to the examined artery segment, said lines being at regularly spaced locations along the X-axis of the artery.

A problem is that the cited document relates to an image processing method based on image acquisition with ultrasound scanning lines that are perpendicular to the artery axis. This corresponds to the use of an ultrasound system for acquiring the ultrasound data with a linear array of transducer elements. This kind of system is appropriate for studying a shallow artery and a small segment of artery such as the carotid. This kind of system is not appropriate for the study of a deep and thick artery such as the aorta and particularly for the study of Abdominal Aortic Aneurysms (AAA). For studying the aorta and AAA, a curved array of transducer elements is preferably used. When the ultrasound data are acquired with a curved array, then the method disclosed in the cited document for calculating artery dilations cannot be directly used, since the scanning lines are no longer perpendicular to the artery axis.

In order to early diagnosing aneurysms in aorta, the medical field has a need for non-invasive means for providing aorta images together with clear quantified indications of the aortic dilation.

### SUMMARY OF THE INVENTION

In order to address the problem of finding new diagnosis information for the follow up of patients suspected to present Abdominal Aortic Aneurysms (AAAs), it is an object of the invention to propose an ultrasonic imaging system for acquiring a sequence of medical images of an artery segment using a curved array of transducer elements. This system has processing means and display means to produce a sequence of images of artery walls with specific patterns for visually setting in evidence artery wall anomalies. The system of the invention is specially designed to constitute a tool for non-invasive study of anomalies of a deep artery such as the aorta.

This ultrasonic imaging system is claimed in claim 1.

It is also an object of the invention to propose an ultrasound apparatus having such an ultrasonic imaging system. It is a further object of the invention to propose an image processing method for displaying an image sequence of deep arteries. In particular, it is an object of the invention to propose an image processing method for evaluation of parameters related to the tension and strain of the aneurysm walls of the aorta. The present invention proposes a method developed for AAAs that is specifically designed to provide clinicians with information on the motion of the aorta artery walls. This image processing method offers the advantage that the aorta wall behavior is made clearly visible together with the parameters that are useful for the clinician in the study of these Abdominal Aortic Aneurysms.

### BRIEF DESCRIPTION OF THE FIGURES

Specific embodiments of the invention will be described in detail hereinafter with reference to the accompanying diagrammatic drawings; therein:

FIG. 1 shows a schematic representation of an aorta and Abdominal Aortic Aneurysm (AAA);

FIG. 2A is a block diagram showing the main steps of the method of the invention;

FIG. 2B is a block diagram of an examination apparatus with a viewing system having processing and display means for carrying out the method of the invention;

FIG. 3 illustrates the geometry of the scanning and raw color data storing order;

FIG. 4 illustrates the weights applied to evaluate best depth for intersection between color lines and structures;

FIG. 5 shows an ultrasound image with color lines and structures and the intersection between color lines and structures;

FIG. 6 illustrates the principle of motion amplitude correction for continuity between cardiac cycles;

FIG. 7 represents a color line and a projection line with respective angle from reference;

FIG. 8 shows a display of the artery walls and motions for each frame of the sequence;

FIG. 9 shows a user interface to summarize the aorta behavior, with annotations to provide information on the meaning of the different lines and sections.

### DETAILED DESCRIPTION OF EMBODIMENTS

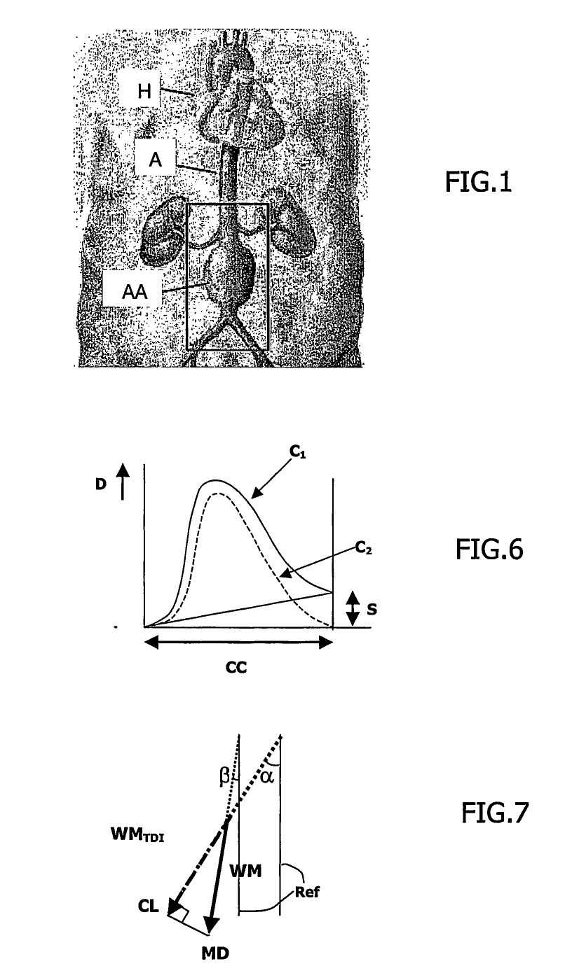

Referring to FIG. 1A, Abdominal Aortic Aneurysm AAA is defined by a doubling of the normal diameter of the infra-renal aorta A. The heart is denoted by H. The AAA abnormality is present in 5% of men aged over 65 years. Rupture of the aneurysm, the most common complication of AAA, is responsible for about 2% of deaths in men in this age group and is the tenth leading cause of death in men in Europe. Since most AAAs are asymptomatic until rupture occurs, up to 50% of all AAAs repairs are performed as an emergency operation. As the operative mortality for ruptured AAA is around 50%, and only a small fraction of patients with ruptured AAAs survive to reach hospital, the overall community mortality for ruptured AAAs is estimated at over 90%. For this reason, there is an increasing interest in the clinical and cost effectiveness of mass screening programs for AAAs. Acquired abdominal aortic aneurysms classically are characterized anatomically by an unparallelism of the aorta edges, resulting in an expanded and beating abdominal mass. The physiopathology consists of a loss of vascular contention, including a risk of rupture. Indeed, the aorta fulfills several haemodynamic functions of blood tissue distribution, damping of the pulse wave, etc. The most elementary of these functions is containing high pressure blood within the arterial lumen. Arterial wall aneurysmal diseases are characterized by partial loss of integrity called dilation or total loss of integrity corresponding to a rupture. Therefore, in order to early diagnosing aneurysms in aorta, the medical field has a need for non-invasive means for providing aorta images together with clear quantified indications of the aortic distensibility. Besides, it is important to use non-invasive means instead of invasive means because invasive means modifies the aorta pressure, hence the actual aorta distensibility.

The severity of Abdominal Aortic Aneurysm (AAAs) is generally clinically estimated by considering its maximal diameter. Failure occurs when the wall stress exceeds the strength of the artery walls. Whereas operative indications for elective AAA repair are generally based on aneurysm size greater than 4.5 to 5 cm in diameter, the most frequently used medical approach is watchful waiting, whereby aneurysm diameter is periodically re-measured to detect expansion to a size warranting surgery of the patient. Now, it is also known that AAAs with a diameter less than 5 cm can rupture. Hence, there is a clear need for additional diagnosis information related to dilation.

The present invention proposes an image processing method to provide aorta parameters for the evaluation of the tension and strain of the aneurysms walls. This method is developed for AAAs and is specifically designed to provide clinicians with information on the behavior of the aortic artery walls. This method permits of evaluating automatically, or with limited user interaction, and at any time in the image sequence, the position of the artery walls, in order to estimate the artery dilations and distensibility.

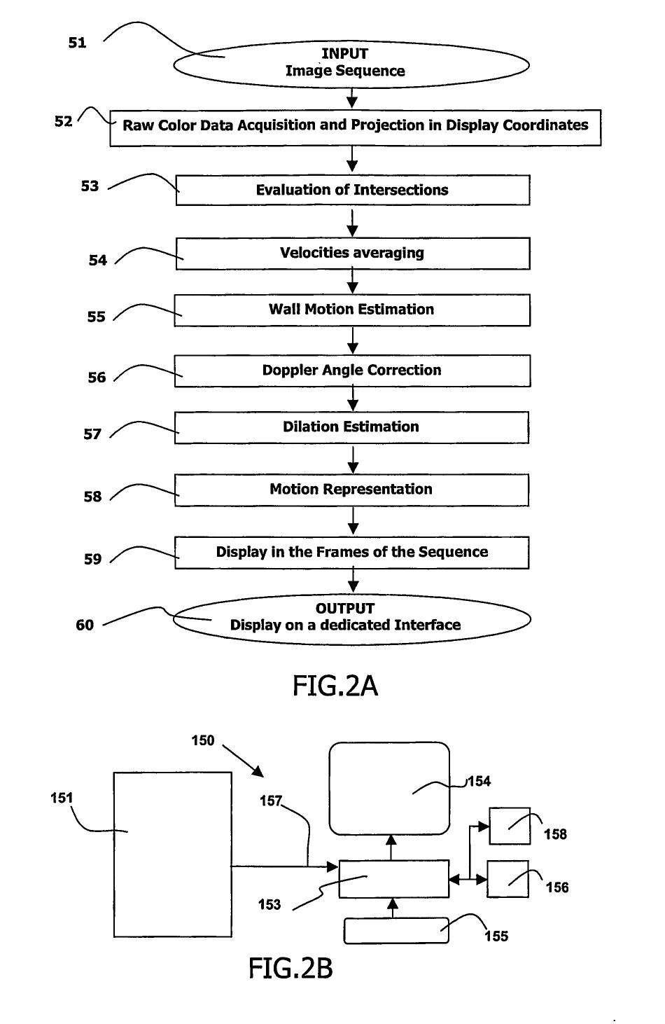

Referring to the block diagram of FIG. 2A, the processing of an image sequence comprises the following main steps of:

1) Acquisition of the Image Sequence 51:

This Abdominal Aortic Aneurysm Wall Motion (AAAWM) tool first comprises means for acquiring of a sequence of ultrasound images of a segment of artery, for instance a segment of aorta, using a linear curved array. Said artery segment has a longitudinal axis and is represented in grayscale images in FIG. 5 or FIG. 9. As a matter of example, the processed sequence of abdominal aortic aneurysms (AAA) has been acquired using a C5-2 probe and a Philips HDI5000 scanner.

FIG. 2B shows a diagram of a medical viewing system 150 according to the invention for carrying out the steps of the image processing method described hereafter. The system has means 151 for acquiring digital image data of a sequence of images, and is coupled to computer means 153 for processing these data according to this image processing method.

The data processing device 153 is programmed to implement a method of processing medical image data according to invention. In particular, the data processing device 153 has computing means and memory means to perform the steps of the method. A computer program product having pre-programmed instructions to carry out the method may also be implemented.

The computer means 153 can be used in the intervention room or near the intervention room for processing sequence images. Steps of the present method can be applied on stored medical images, for example for estimating medical parameters. The medical viewing system provides the image data by connection 157 to the system 153. The system provides processed image data to display means and/or storage means. The display means 154 may be a screen. The storage means may be a memory of the system 153. Said storage means may be alternately external storage means. This image viewing system 153 may comprise a suitably programmed computer, or a special purpose processor having circuit means such as LUTs, Memories, Filters, Logic Operators, that are arranged to perform the functions of the method steps according to the invention. The system 153 may also comprise a keyboard 155 and a mouse 156. Icones may be provided on the screen to be activated by mouse-clicks, or special pushbuttons may be provided on the system, to constitute control means 158 for the user to actuate the processing means of the system at chosen stages of the method.

The means 151 for acquiring digital image data of a sequence of images may be an ultrasound examination apparatus coupled to this medical viewing system 150. This medical examination apparatus 151 may include a bed on which the patient lies or another element for localizing the patient relative to the apparatus. The image data produced by the ultrasound examination apparatus 151 is fed to the medical viewing system 150.

The image processing method of the invention, for forming the Abdominal Aortic Aneurysm Wall Motion (AAAWM) tool, is described hereafter more precisely. In the following, the terms artery wall border and “structure” have the same meaning and represent a segmented object. This image processing method comprises further steps of:

2) Raw Color Information Acquisition and Projection in Display Coordinates 52:

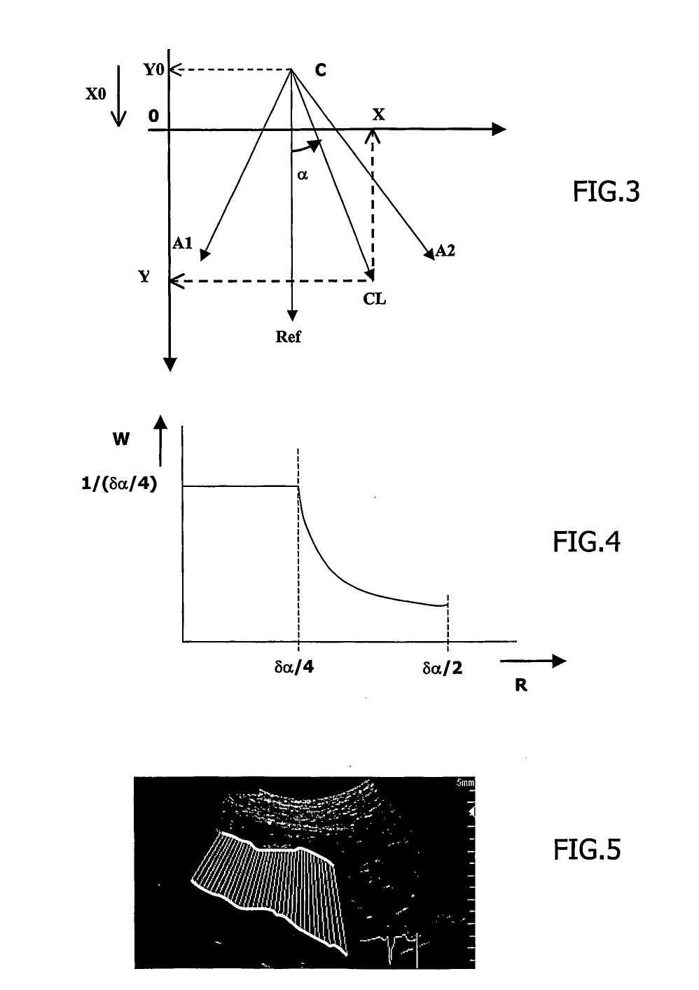

The segment of artery is further color scanned using the curved array of transducer elements. Since the transducer array is curved, the method disclosed in the cited prior art cannot be directly used. Scanning with the curved array, in an ultrasound color mode, for example with a Tissue Doppler Imaging (TDI) modality, permits of acquiring ultrasound color data related to motion of tissue. The ultrasound raw color data provides the ultrasound information for processing the artery wall motion. The ultrasound information is composed of the lines or beams of the ultrasound color scanning and, for each ultrasound line, the estimates of velocities of the artery walls along the ultrasound color lines in depth. Color geometry of the scanning and raw color data storing order of the color acquisition is represented in FIG. 3. Referring to FIG. 3, in the method developed for the AAAs, the indexes (angle index, depth index) of the ultrasound raw color data must be converted into display coordinates (X,Y) in order to match the ultrasound color information with the position of the artery walls. The equations (1a, 1b) of the transformation, for the conversion of an index (angle index, depth index) in the ultrasound color raw domain into the display domain in pixels (X,Y), are presented hereafter. In this FIG. 3: C is the scanning center; X0, Y0 are the position of C in display coordinates of the display domain; A1 is the starting angle; A2 is the stopping angle; CL is the current color line; Ref is the Reference Angle=0°. In these equations:

StopAngle and StartAngle refer to the stop angle and start angle in radians of the ultrasound color information or ultrasound color beam;

NumAngles is the number of beam angles in the color data;

δα is the interval in radians between two successive color beams at two respective angles;

δdepth is the interval in pixels between two successive color estimates on a given beam at a respective angle;

α is the current angle in radian of a current beam corresponding to the angle index in the color domain;

depth is the depth in pixels corresponding to the depth index in the color domain;

(X,Y) is the position of (angle index, depth index) in the display domain, in pixels.
δα=(StopAngle−StartAngle)/NumAngles
δdepth=(StopDepth−StartDepth)/NumDepths
α=StartAngle+angle_Index*δα
depth=StartDepth+depth_Index*δdepth
X=X0−sin(α)*depth (1a)
Y=Y0+cos(α)*depth (1b)

3) Evaluation of the Intersections Between Structures and Color Information 53:

The structures are the two internal boundaries of the artery walls that are to be previously determined, for example using the method described in the cited prior art. The structures are determined using the gray scale images. The structures are reported in the raw color data frames.

From now on, the color lines that are used in the display are the display color lines whose angles are calculated as above from the ultrasound color lines. The ultrasound color estimates at each depth are calculated and reported on the color lines for display as follows.

The indexes that correspond to intersections of the color lines with the structures are determined in the raw color data frames in the ultrasound color domain. For each frame and each structure, the points of the structure are associated with their distance to the closest color estimate. Each pixel of the structure is associated to the closest line angle in the color domain. Then, for all the pixels associated to the same color line angle, the depth is estimated as follows: the final depth in the color domain is the gravity center of the depths of the considered pixels. The weights W are defined as the inverse of the remainder, denoted by R, between the closest line angle in the color domain and the line angle between the pixel and the scanning center C. For small remainders, the weight function is thresholded as shown in FIG. 4, which represents the weights W applied to evaluate the best depths for intersections between color lines and structures. In FIG. 4, δα is the distance in radians between two successive color line angles in radian, and (δα/2) is the maximum remainder R.

A result of the estimation of the intersections between the color lines and the structures is presented in FIG. 5. The extremities of the small fine lines represent the intersection between color lines and the artery wall boundaries that are called reference structures. When there is no intersection between a color line and the reference structures, or no intersection with only one of the reference structures, the color information of the corresponding line can not be used to evaluate the artery dilations and thus is not considered for further processing.

4) Velocities Averaging 54

For each structure, the velocity associated with each color line is the result of an averaging of a few velocities. The number of indexes selected for the averaging depends on the width in mm of the wall. The usual value for the wall thickness is for example 1 mm. In order to limit the influence of noisy data when the velocities are estimated at positions too close to the artery border, the averaging can be performed on velocities corresponding to positions located more inside the walls. An offset variable has been defined to specify the amplitude of the displacement towards the inner parts of the walls. It can also be set to 0 if no offset is required. A global averaging of the velocities for each of the structures provides a mean to estimate the cardiac cycles beginnings for the whole sequence.

5) Wall Motion Estimations 55

For each color line, the velocities of each structure are integrated over time, for example over a cardiac cycle, since the cardiac cycles beginnings have been previously determined, which permits of determining the cardiac cycle duration. This provides motion information of a structure along each color line over time. Since the integration constant remains unknown, the motion of a structure is not perfectly cyclic and the amplitude of the motion at the end of a cardiac cycle can be different from 0, thus showing a shift S. In order to provide comprehensible information about motion of the artery walls, a choice is made to reset to 0 the amplitude of the motion at the end of each cardiac cycle. In order to keep continuity of motion, an affine correction of the data is performed in each cardiac cycle. FIG. 6 illustrates the principle of motion amplitude correction for continuity between cardiac cycles. The amplitude of motion before correction is represented by the curve C1. The amplitude of motion after correction is represented by the curve C2.

6) Doppler Angle Correction 56

The amplitude of the wall motion is corrected to compensate for the Doppler angle. FIG. 7 is a view of the color line and the projection line, with respective angle from a reference angle denoted by Ref. In FIG. 7, the reference angle Ref is represented by a vertical line. The angle of the color line denoted by CL is represented as a doted line and its value is called α. The angle of the estimated motion direction denoted by MD is represented with a bold line and its value is called β. The angles are taken in the trigonometric orientation and are signed. Thus, the resulting Doppler angle between the color line CL and the projection line is the difference of α and β.

The corrected motion amplitude is calculated using the following equation (2), which gives the motion amplitude correction using the Doppler angle, where WM represents the corrected motion amplitude of the measured motion amplitude WM_{TDI}.

$$WM = \frac{{WM}_{TDI}}{cos ( α - β )} \qquad ( 2 )$$

7) Dilations Estimation 57

The dilation estimation is the result of the difference of motion between the two structures (artery wall boundaries) for each color line CL. The dilations are calculated in order to provide input data for the interface of the application. The distensibility is the ratio between the dilation and the diameter of the artery.

8) Motion Representation 58

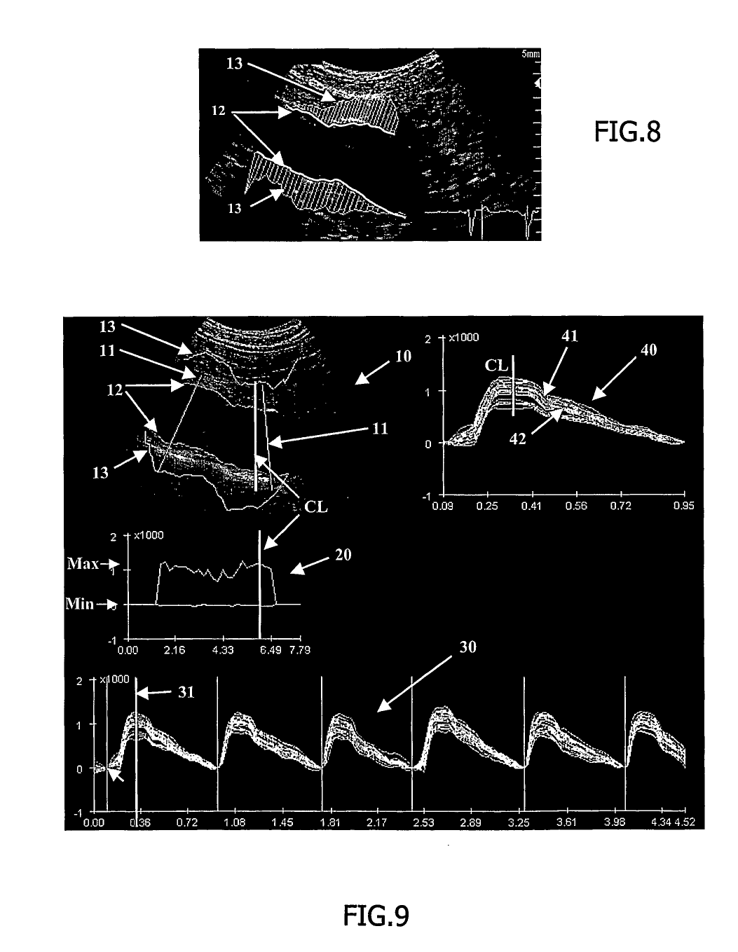

In order to represent the motion in the images, a choice must be made regarding the estimated direction of the motion. In this application, the hypothesis is that the motion of the artery walls is perpendicular to the artery principal axis. This is illustrated by FIG. 8, which shows the motion estimation of each structure represented on the normal to the global artery axis, externally to the reference structures.

9) Display in the Frames of the Sequence 59

Referring to FIG. 8, the display provided in each frame of the sequence is limited to two types of information. The first type is the structure location. The proximal and distal walls are represented in color in order to be more easily visualized by the user. For instance the two wall structures are represented in the same color. Then, the motion of each wall along each color line is represented in a second color to be more easily distinguished by the user. The reference line for a null motion is the structure itself, called reference structure, and the motion amplitudes are represented starting from the reference structure position. The representation of the lines of the second color, and direction normal to the artery axis, for each motion amplitude, allows of understanding the direction of projection that is selected. The lines of said second color are interconnected to represent the overall shape of the motion between the lines of the second color. FIG. 9 shows a display of the artery walls and motions for each frame of a sequence.

10) Display on a Dedicated Interface 60

After the processing, the results are summarized on a dedicated interface as shown in FIG. 9. FIG. 9 is a user interface to summarize the aorta behavior, annotated in boxes to provide information on the meaning of the different lines and selections.

The upper left part of the interface presents an echo image, referred to by 10, corresponding to the user selected frame, combined with the segmentation result for the proximal and distal walls and the dilation amplitudes of motion for said proximal and distal walls. The selected current color line is shown:
11 are the selected limits of color;
12 represent the segmentations of proximal and distal walls;
13 are the motions of proximal and distal walls;
CL is the current color line.

The middle left part displays curves, referred to by 20, of the maximum amplitude and minimum amplitude of the dilations for a given cardiac cycle, as a function of the color lines. The selected current color line is associated to the display of the same color line in the echo image 10:
Max is the maximum dilation per line in the current cardiac cycle;
Min is the minimum dilation per line in the current cardiac cycle.

In the lower left part of the display, the amplitudes of the dilations, referred to by 30, are displayed as a function of time. It allows of comparing the amplitudes of the dilations between different color lines:

31 is the selected time t in the sequence;

32 is the current cardiac cycle.

The upper right part presents the dilation amplitudes, referred to by 40, for the cardiac cycle selected by the user:
41 is the mean dilation for current cardiac cycle;
42 is the dilation of selected color line for current cardiac cycle.

The user may have an interaction with clicks of the mouse of the ultrasound system in order to select the color line CL in display 10 or 20 or 40; or the time t represented by 31 in display 30 of FIG. 10.

1. An ultrasonic viewing system, for displaying images of an artery using a curved array of transducer elements, comprising means for acquiring of an ultrasonic image sequence and a Doppler color sequence of a segment of artery explored along its longitudinal axis and having walls moving in relation with the cardiac cycle; and comprising processing means for:
estimating the velocity and motion amplitude of the artery walls along Doppler color ultrasound scanning lines;
estimating the motion amplitude of the artery walls along lines perpendicular to the artery global axis; and further comprising:
display means for displaying curves of this last artery wall amplitude on a dedicated display on which the user may have interaction.

2. The viewing system of claim 1, wherein the processing means for estimating the artery walls motion amplitude along lines perpendicular to the artery global axis comprises means for:
estimating the artery walls motion amplitude (WM) in the direction of motion (MD) in function of the motion amplitude (WM_{TDI}) measured along the Doppler color line corrected to compensate for the Doppler angle.

3. The viewing system of claim 2, wherein the processing means for estimating the artery walls motion amplitude along Doppler color ultrasound scanning lines comprises means for segmenting the artery walls, providing wall structures; and means for:
calculating intersections between the Doppler color lines and the structures;
estimating time references and integrating velocities of each structure over a time delay between two time references to provide walls motion estimation.

4. The viewing system of claim 3, wherein the walls motion estimation is corrected by a shift of the amplitude of motion to reset the amplitude to zero at an instant of the time delay when the walls have no motion.

5. The viewing system of claim 1, comprising means for evaluating (57) artery dilation as the difference of motion of the two structures of the artery for each Doppler color line.

6. The viewing system of claim 5, comprising means for:
providing velocities associated to each Doppler color line as a result of the averaging of a few velocities;
providing global averaging of the velocities for each structure to estimate the time references as the beginnings of the cardiac cycles.

7. The viewing system of claim 1, having means to display information in each frame of the sequence comprising:
the structure location;
the motion of each structure measured along the color lines and displayed along the perpendicular to the artery axis;
lines representing the overall shapes of the motions.

8. The viewing system of claim 1, wherein the interface display comprises displays among the following:
display of an echo image corresponding to a selected user frame, combined with the segmentation result for the artery walls and the dilation amplitudes of motion for said walls;
display curves of the maximum and minimum amplitudes of the dilations for a given cardiac cycle as a function of a color line as selected in the display of the echo image;
display of the amplitude of dilation as a function of time over several cardiac cycles; and
display of the amplitude of dilation as a function of time for a cardiac cycle selected by the user.

9. The viewing system of claim 8, having color display means to display colored structures for the artery walls and colored patterns for the wall dilation, superimposed on the ultrasonic images.

10. An image processing method, comprising the steps of:
acquiring of an ultrasonic image sequence and a Doppler color sequence of a segment of artery explored along its longitudinal axis and having walls moving in relation with the cardiac cycle; and comprising processing steps of:
estimating the velocity and motion amplitude of the artery walls along Doppler color ultrasound scanning lines;
estimating the motion amplitude of the artery walls along lines perpendicular to the artery global axis; and further comprising steps of:
displaying curves of this last artery wall amplitude on a dedicated display on which the user may have interaction.

11. The viewing system as claimed in claim 1, comprising a suitably programmed computer of a workstation or a special purpose processor having circuit means, which are arranged to process ultrasonic images according to the method, having means to display the images processed according to said method, and having a user interface such as a mouse or a keyboard to permit the user of interacting on the respective images of the sequence in order to display the quantified parameters related to the artery walls.

12. (canceled)

13. The viewing system of claim 4, comprising means for evaluating artery dilation as the difference of motion of the two structures of the artery for each Doppler color line.

14. The viewing system of claim 6, having means to display information in each frame of the sequence comprising:
the structure location;
the motion of each structure measured along the color lines and displayed along the perpendicular to the artery axis;
lines representing the overall shapes of the motions.

15. The viewing system of claim 7, wherein the interface display comprises displays among the following:
display of an echo image corresponding to a selected user frame, combined with the segmentation result for the artery walls and the dilation amplitudes of motion for said walls;
display curves of the maximum and minimum amplitudes of the dilations for a given cardiac cycle as a function of a color line as selected in the display of the echo image;
display of the amplitude of dilation as a function of time over several cardiac cycles; and
display of the amplitude of dilation as a function of time for a cardiac cycle selected by the user.

16. The viewing system as claimed in claim 9, comprising a suitably programmed computer of a workstation or a special purpose processor having circuit means, which are arranged to process ultrasonic images according to the method, having means to display the images processed according to said method, and having a user interface such as a mouse or a keyboard to permit the user of interacting on the respective images of the sequence in order to display the quantified parameters related to the artery walls.
